(19) United States
(12) Patent Application Publication
(10) Pub. No.: US 2018/0181966 A1
(43) Pub. Date: Jun. 28, 2018

(54) Referral and Collaboration Based Social Media Platform for Brand Marketing, Brand Management, and Customer Relations Management

(71) Applicant: Sunil K Rao, Palo Alto, CA (US)

(72) Inventors: Raman K. Rao, Palo Alto, CA (US); Sunil K. Rao, Palo Alto, CA (US)

(21) Appl. No.: 13/733,209

(22) Filed: Jan. 3, 2013

(51) Int. Cl. G06Q 30/00; G06Q 50/00

(52) U.S. Cl. CPC G06Q 30/01; G06Q 50/01

(57) ABSTRACT

A marketing and CRM platform for restaurants, grocery stores, pharmaceutical companies, retail establishments, online eCommerce retailers, in conjunction with a vendor profile, customer profile, and social network is described. The platform may provide incentives, loyalty, discounts, sales, markdowns, barcode coupons and offers from vendors and customers, for engagement activity in-store or online or referral of customers to the vendor, customer, or group's social networks. The platform may recognize and identify people by device, RFID, or credit card/magnetic reader swipe; track, and analyze customer activity; issue rewards and rebates for transactions and milestones including birthdays or group purchases; provide analytics to the vendor; enable reviews, ratings, stars, scores, “thumbs up/down”, indications of support and product interest; and suggest culinary, menu item, and vendor information. The platform may be accessible using stationary devices, cellular telephones, smartphones, mobile devices, smartcards, RFID cards, email, intelligent point of sale terminals or electronic devices.

### CROSS REFERENCE TO RELATED APPLICATIONS

The present application is a continuation-in-part of co-pending application Ser. No. 13/559,486 titled “Social Media System with Multiple Profiles”, filed on Jul. 26, 2012, which is a continuation of the prior application Ser. No. 12/982,805 filed on Dec. 30, 2010, which is now an issued U.S. Pat. No. 8,234,346 dated Jul. 31, 2012, which is a continuation of application Ser. No. 10/644,276 filed on Aug. 20, 2003 now U.S. Pat. No. 7,890,581 dated Feb. 15, 2011; the present application claims priority to all of the above referenced applications.

### BACKGROUND

Rao et al teach a social network, matching network, and social media system in the parent and present applications. Rao et al in the present application teach a Brand and Social Network Platform for enhanced utility to a broad range of applications related to customers, vendors, social networks, matching, and social media systems. Brand and vendor networks may include individuals, friends, contacts, customers, vendors, information sources, and products. The customer profiles that Rao et al teach includes various types of information that is deemed necessary by the customer and or the vendor for different types of interactions and communications. The customer profile may also include the photo and other pertinent information related to the customer and or the vendor. The types of communications that Rao et al teach include e-mail communication and other types of communication that include voice, audio, video, graphics, images and data in one or more languages, said communication being enabled between the customer and one or more vendors and further includes communication between the individual customer and one or more other individual users. Rao et al teach the establishment of a customer profile by the individual user and or the vendor for various types of communications between the customer and the vendor including other individuals and entities such as authorized health care providers. Rao et al in the present application teach novel methods for enhanced utility to a broad range of applications.

Rao et al teach a system and method for efficiently organizing the customer profiles [including a photo and other pertinent information], vendor profiles [including a photo and other pertinent information], and different types of communication/interactions between the customer and the vendor, between one or more customers, and between one or more vendors to provide enhanced utility, wherein said utility includes developing strong and lasting commercial relationships between the vendor and the customer, between one or more customers for collaborative purchasing/information transactions and between one or more vendors for collaborative information/marketing to each others customers or to a selected joint set of customers. There is a need for the vendor to promote the brand of the vendor, create loyal customers, increase the number of customers through referrals, know the specific individual customers in detail and actively communicate with the current and potential customers. There is a need for the vendor to proactively develop and manage the vendor's brand by establishing one to one relationship between the customer and the vendor for providing products and or services desired by the customer and provided by the vendor. Similarly, there is a need for the customers to communicate with others such as members of the family, friends, co workers and others to refer a vendor or to collaborate in the purchase of various products and services. In addition, there is a need to provide trusted inputs to other individuals and or groups of their choosing regarding a vendor and the vendor's products and services.

In a similar manner, there is a need for one or more vendors to collaborate to enable marketing of products and services that are complementary to the respective vendors; such that the customers of the first vendor enable improved sales for the second vendor through shared communication with their respective individual customers and customer bases.

Specifically, there is a need for the vendor to leverage the power of the individual customer and the existing customer's ability to refer the vendor to one or more of the customer's contacts. Alternately, there is a need for efficient interaction and communication between various individuals [customers] to share, evaluate and use the knowledge and information available to an individual [current customer] with others [potential new customers] that the individual is in contact with. Culinary and consumption information is highly subjective and depends on the taste palate and health preferences of the individual customer. Other individuals that are known to a satisfied/dissatisfied customer are likely to be influenced by the opinions, and inputs of the individual customer thus affecting the sales and reputation of the specific vendor.

Similarly, the consumption and purchasing preferences of various individual customers for different other types of products and services, to a large measure is influenced by the recommendation of trusted sources, the reviews provided by the trusted sources related to different vendors, products and services; and the willingness of the specific existing individual customer to refer other potential customers to a specific vendor.

The system and method of an embodiment of the Brand and Social Media Platform is generally related to a broad array of Internet [wired and wireless communication] based referral and collaboration driven marketing, sales, purchasing, loyalty programs, brand management and other application for the retail industry, for other enterprises and a broad spectrum of consumers; and is not to be construed as limited to culinary applications alone but equally applicable to various other products, services and retail, wholesale and other commercial and non commercial applications.

### SUMMARY

1. An object of an embodiment of the Brand and Social Media Platform is to enable a rich customer profile comprising of photo, still images, audio, video, graphics, text, data and other information for use in personal referral networks and for use in brand networks (social networks).

2. An object of an embodiment of the Brand and Social Media Platform is to enable a rich vendor profile comprising of photo, still images, audio, video, graphics, text, data and other information for use in personal referral networks and for use in brand networks (social networks).

3. An object of an embodiment of the Brand and Social Media Platform is to enable brand networks (social networks) for one or more vendors, to enable the vendor to communicate in real time or at selected times with its existing customers.

4. An object of an embodiment of the Brand and Social Media Platform is to enable brand networks (social networks) for one or more vendors, to enable the vendor to communicate in real time or at selected times with its existing customers and incentivize its existing customers to refer other individuals that they know to join the vendor's specific brand network.

5. An object of an embodiment of the Brand and Social Media Platform is to enable customers to join brand networks (social networks) of a selected vendor for deriving various benefits from said vendor and said brand network

6. An object of an embodiment of the Brand and Social Media Platform is to enable customers to create personal referral networks within a vendor's brand network or external of a vendor's brand network in order to refer others that they know to, said vendor's brand network for deriving various benefits from said vendor and said brand network and for collaboration between one or more individuals/customers.

7. An object of an embodiment of the Brand and Social Media Platform is to provide a system and software platform for marketing and managing one or more brands of a vendor and for enabling brand based marketing.

8. An object of an embodiment of the Brand and Social Media Platform is to provide a system and software platform for customer relations management of a specific brand of a vendor and other sub brands of a vendor.

9. An object of an embodiment of the Brand and Social Media Platform is to provide a system and software platform in conjunction with cellular telephones, smart phones, PDAs, mobile devices, stationary devices, servers and intelligent appliances such as intelligent point of sale terminals for marketing, managing and customer relationship management of one or more brands of a vendor and for enabling brand based marketing.

10. An object of an embodiment of the Brand and Social Media Platform is to provide a system and software platform in conjunction with cellular telephones, smart phones, PDAs, mobile devices, stationary devices, servers and intelligent appliances such as intelligent point of sale terminals for delivering promotions, coupons, incentives by automatic customer profile recognition by wired or wireless communication.

Other objects, features and advantages of an embodiment of the Brand and Social Media Platform will become apparent from the following detailed description when taken in conjunction with the accompanying drawings.

### BRIEF DESCRIPTION OF THE EMBODIMENTS

The accompanying drawings, which are incorporated in and form a part of this specification, illustrate embodiments of an embodiment of the Brand and Social Media Platform and, together with the description, serve to explain the principles of an embodiment of the Brand and Social Media Platform:

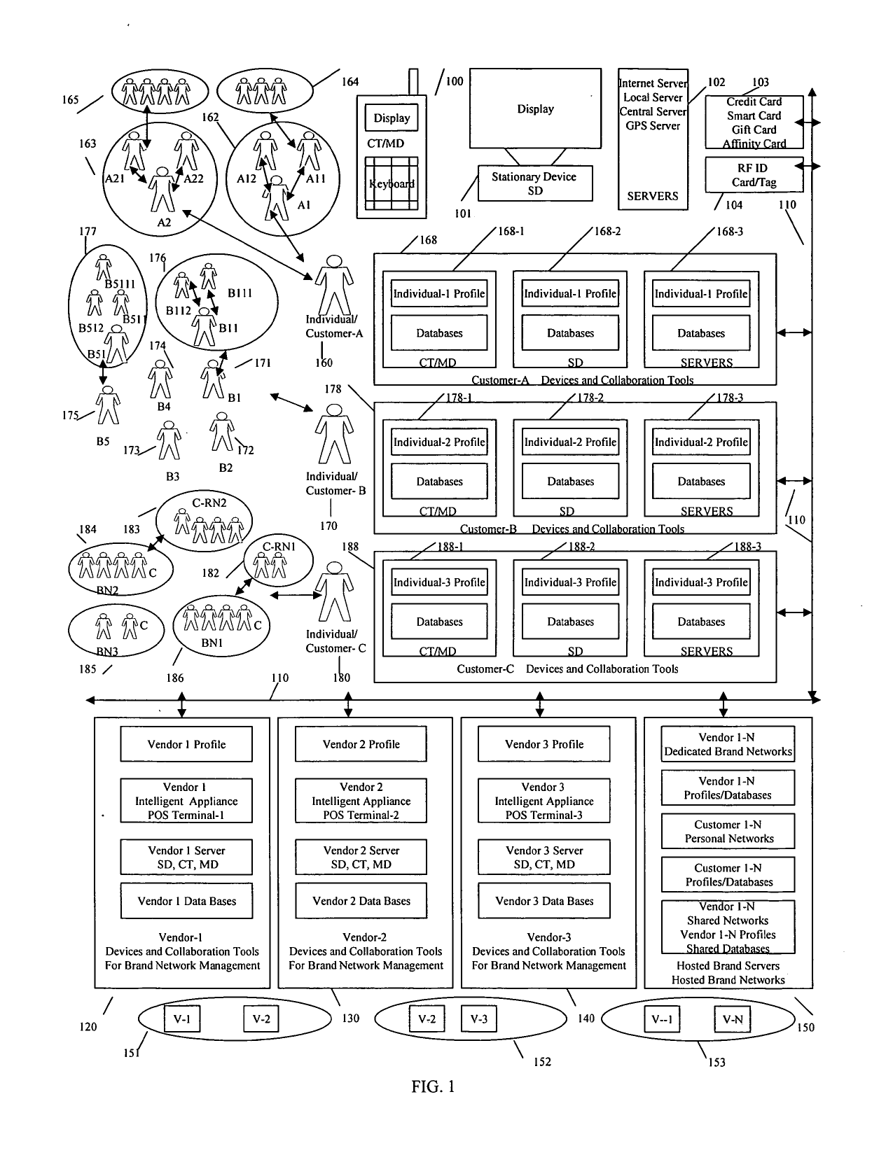

FIG. 1 shows various detailed embodiments and system level architecture of a referral and collaboration system of an embodiment of the Brand and Social Media Platform for creating and managing various types of referral, brand and vendor networks.

### DETAILED DESCRIPTION OF THE EMBODIMENTS

Reference will now be made in detail to the preferred embodiments of the Brand and Social Media Platform, examples of which are illustrated in the accompanying drawings. While an embodiment of the Brand and Social Media Platform will be described in conjunction with the preferred embodiments, it will be understood that they are not intended to limit an embodiment of the Brand and Social Media Platform to those embodiments. On the contrary, an embodiment of the Brand and Social Media Platform is intended to cover alternatives, modifications and equivalents, which may be included within the spirit and scope of an embodiment of the Brand and Social Media Platform as defined by the appended claims. For example, the embodiments that follow relate to a wireless unit such as a cellular telephone, CT, a mobile computation and or communication device, MD and other mobile devices such as personal digital assistants, PDA, smart phones, and laptop computers for making obtaining information, making decisions and for transactions; but include stationary devices, SD, as well, such as personal computers (PCs) and point of sale terminals (POS), intelligent appliances for different applications such as intelligent point of sale terminals. Further, the inquiry or request can be in any form of intelligence, such as key entries from a keyboard, voice in any language, graphics such as a key click on a graphic page, mouse clicks on a view, or even tactile responses or depressions of a mechanical device such as a foot pedal. Required translations, such as from one language to another or from a tactile entry to a voice command, are made automatically.

FIG. 1 shows various detailed embodiments and system level architecture of a referral and collaboration based system of an embodiment of the Brand and Social Media Platform for providing information and management capabilities that enable customers to create one or more personal referral networks, RN, to communicate and collaborate with other individuals who may be current customers of a particular vendor and or potential customers of the particular vendor; enables vendors to create brand networks (social networks), BN, for communicating with current customers, potential new customers and for customer relations management, CRM; and further enables multiple vendors to create one or more vendor networks, VN for collaboration between one or more vendors in order to provide complementary services to each others brand network members to individually and or jointly provide services to the full set or a shared set of the brand network of the first vendor and the second vendor.

Referring to FIG. 1 in detail, the devices and tools available to an individual for computation and communication are a cellular telephone, CT 100; a mobile device MD 100, such as a personal digital assistant, PDA, a laptop computer and other mobile devices; a stationary device SD 101 such as a personal computer PC; one or more servers 102 such a local server, a central server and an Internet server. The communication is enabled between one or more cellular telephones, mobile devices, stationary devices, servers and intelligent appliances such as an intelligent point of sale terminal by wired or wireless means represented by 110, using one or more wired or wireless communication methods on one or more selected channels of said computation and communication devices.

Once again referring to FIG. 1, in one preferred embodiment of the architecture and system configuration of the Brand and Social Media Platform, one or more vendors maintain their own websites and servers or rely on hosted websites and hosted servers. Namely, Vendor-1 maintains various devices and collaboration tools for brand management as represented in FIG. 1 by the legend 120; wherein the devices and tools comprises of a Vendor-1 profile, one or more Vendor-1 intelligent point of sale terminals, one or more Vendor-1 servers, stationary devices SD, cellular telephones CT, mobile devices MD and one or more Vendor-1 data bases/storage devices. Similarly, Vendor-2 has capabilities as represented by 130 with a Vendor-2 profile, one or more Vendor-2 intelligent point of sale terminals, one or more Vendor-2 servers, stationary devices SD, cellular telephones CT, mobile devices MD, and one or more Vendor-2 data bases/storage devices; and Vendor-3 has capabilities as represented by 140 with a Vendor-3 profile, one or more Vendor-3 intelligent point of sale terminals, one or more Vendor-3 servers, stationary devices SD, cellular telephones CT, mobile devices MD and one or more Vendor-3 data bases/storage devices. The communication between Vendor-1, Vendor-2 and Vendor-3 and with various other customers/devices is enabled by wired or wireless communication means, 110, within a local network, a wide area network or via the Internet.

Once again referring to FIG. 1, in one preferred embodiment of the architecture and system configuration of the Brand and Social Media Platform that includes a hosted model with hosted brand servers and hosted brand networks (social networks) and or hosted personal referral networks represented in combination by the block 150. In this configuration, one or more vendors Vendor-1 through Vendor-N may alternately or in addition host their services on an external server and or utilize external storage devices and databases. The communication path 110 in such a hosted model is by wired or wireless communication means. In such a hosted model and system configuration, the vendors 1-N are enabled to offer services to the customers seamlessly by appropriate links and link forwarding such that the user obtains the needed services without being aware that the services are being offered via a hosted server. Each Vendor is enabled to maintain their own dedicated and secure brand network, vendor profiles, vendor databases and vendor storage. Similarly each customer is enabled to maintain his/her personal referral networks within this hosted model configuration with dedicated and secure customer profiles, dedicated storage and dedicated databases.

In addition, in another novel embodiment of an embodiment of the Brand and Social Media Platform referring to the hosted model configuration 150, one or more vendors are enabled to host and maintain shared vendor networks; wherein selected and or complete vendor specific brand network information is securely shared between one or more participating vendors [as per their agreement] to provide complementary products and services to one or more of their customers in a selected brand network of the first vendor or the second vendor or a combination thereof. In this configuration a virtual shared brand network, SBN, 151 representing the collaboration of Vendor-1, V-1 and Vendor-2, V-2 is created; a virtual shared brand network 152 representing the collaboration of Vendor-2, V-2 and Vendor-3, V-3; and similarly the shared brand network for vendor's 1-N [V-1 through V-N] 153, is created.

These virtual shared brand networks (social networks), SBN 151, 152 and 153 may be created for a specific task, for a specific product and or service, for specific customers, and may be created at a specific time and may exist for a specific selected duration as determined by the agreement between the first vendor and the second vendor or the Nth vendor. Thus the vendors while adhering to the privacy policies, customer and regulatory commitments are enabled to provide enhanced and complementary services desired by the customers in each of their specific brand networks (social networks) by creating and operating a virtual shared brand network for mutual benefit of the vendors in such a virtual shared brand network and for the benefit of the customers represented in such a virtual shared brand network.

Consequently, as a result of the virtual shared brand network, customers in turn are enabled to create a virtual shared referral network to leverage the benefits that accrue from belonging to a first vendor's brand network but not explicitly belonging to a second vendor's brand network. In this virtual shared brand networking model both vendors and customers benefit from leveraging the information, such customer's product/service reviews, other information and purchasing power of customer's in such virtual shared brand networks (social networks).

Once again referring to FIG. 1, the individuals are represented by 160, 170 and 180 who may be customers of various vendors V-1 through V-N and belong in the brand networks (social networks) of each respective vendor. Individual 160 is enabled to create one or more personal referral network, RN comprising of various individuals who he/she has referred to such a referral network. As an example individual/customer A, 160, may create a personal referral/collaboration network, 162, by refer another individual A1 who in turn refers A11 and A12. This referral/collaboration network may be created for a specific or general purpose as desired by the individual/customer A and others in said referral/collaboration network. Individual A11 from the referral network, 162, may refer other individuals to form a new referral/collaboration network 164 for same or a different purpose. Similarly, individual/customer A may form an alternate referral/collaboration network 163, comprising of individual A2 who in turn refers other individuals/customers A21 and A22. Further individual A21 may create another network 165 by inviting four other individuals. This enables viral growth of the referral/collaboration networks for commercial and other utility.

Individual/customer A, 160 has associated with him/her an array of devices and collaboration tools represented by legend 168, comprising of a CT/MD block 168-1 that includes various individual/customer profiles and various data bases resident within the CT/MD; and or comprising of functional capabilities as represented by the legend 168-2 that includes various individual/customer profiles and various data bases resident within the SD; and or comprising of functional capabilities as represented by the legend 168-3 that include various individual/customer profiles and various data bases resident within one or more servers such as a local server, a central server, a GPS [global positioning system] server, an Internet server or a combination thereof. The individual/customer A, 160, has the option of utilizing the appropriate devices and tools depending upon his/her location such as at home, in the car, in the office or any where. The communication path 110 associated with the various devices enables wired or wireless communication as appropriate for each said device.

Individual/customer B, 170 has associated with him/her an array of devices and collaboration tools represented by legend 178, comprising of a CT/MD block 178-1 that includes various individual/customer profiles and various data bases resident within the CT/MD; and or comprising of functional capabilities as represented by the legend 178-2 that includes various individual/customer profiles and various data bases resident within the SD; and or comprising of functional capabilities as represented in a block diagram for ease of illustration and denoted by the legend 178-3 that include various individual/customer profiles and various data bases resident within one or more servers such as a local server, a central server, a GPS server, an Internet server or a combination thereof. The individual/customer B, 170, has the option of utilizing the appropriate devices and tools depending upon his/her location such as at home, in the car, in the office or any where. The communication path 110 associated with the various devices enables wired or wireless communication as appropriate for each said device.

Individual/customer C, 180 has associated with him/her an array of devices and collaboration tools represented by legend 168, comprising of a CT/MD block 188-1 that includes various individual/customer profiles and various data bases resident within the CT/MD; and or comprising of functional capabilities as represented by the legend 188-2 that includes various individual/customer profiles and various data bases resident within the SD; and or comprising of functional capabilities as represented by the legend 188-3 that include various individual/customer profiles and various data bases resident within one or more servers such as a local server, a central server, a GPS server, an Internet server or a combination thereof. The individual/customer C, 180, has the option of utilizing the appropriate devices and tools depending upon his/her location such as at home, in the car, in the office or any where. The communication path 110 associated with the various devices enables wired or wireless communication as appropriate for each said device.

An embodiment of the Brand and Social Media Platform enables customer and vendor profiles that are rich in content. The customer profiles may include, audio, video, graphics, data, text and other forms of information in one or more selected formats and languages for a range of full utility in conjunction with devices and servers that have the communication, computation, processing, storage, software, database and other capabilities resident therein or available across the local network or the Internet by wired or wireless communication paths.

Referring once again to FIG. 1, individual/customer B, 170, is enabled to create one or more personal referral networks by inviting people to join such networks created for a specific purpose. One such network for collaborative purchasing and information sharing may be a personal shopping network. Customer B 170 refers individuals who may be current customers of a selected vendor or potential customers to join such personal shopping and collaboration networks. Individual/customer B 170 may refer B1, 171; B2 172; B3 173; B4 174 and B5 175 who in turn may or may not join such networks and who in turn may or may not refer others that they know to join such networks. In one illustrative example, individual/customer B 170, refers individual/customer B1 who in turn refers B11. B11 in turn refers B111 and B112. In this scheme individuals B, B1, B11, B111 and B112 form a referral/collaboration network for personal shopping with a selected vendor or one or more vendors for obtaining information related to a specific product/service or a range of products and or services. For further illustration, customer B5, 175 refers B51 who in turn refers B511 and B512; and B511 further refers B5111 who may thus form a referral/collaboration network for a selected purpose for mutual interaction and or interaction with one or more selected vendors.

Referring once again to FIG. 1 in detail, individual/customer C, 180, may form personal referral networks 182 [illustrated with two referred members] and 183 [illustrated with four referred members]. Additionally, vendor 1 may form a brand network BN1, 186; and vendor 2 may form a brand network BN2, 184; and vendor 3 may form a brand network BN3, 185. Customer C, 180 may be a member of each of the respective vendor's brand networks (social networks). The Customer C, 170 in this scheme is enabled to refer friends, family, co-workers and others to all or some of the brand networks (social networks) that the customer C, 180 is a member thereof. It is intended that the vendor is the one that maintains and controls one or more brand networks (social networks), enabling various customers to join such brand networks (social networks) and further refer current and potential customers to form personal referral/collaboration networks within said vendor controlled brand networks (social networks) which operate under pre set rules, security, privacy and other guidelines.

The personal referral networks of a specific customer may operate within a vendor's brand network and operate on a specific vendor's servers/devices/databases/applications software according to the agreements between the vendor and the customer. Alternately the customer may maintain his/her own personal referral/collaboration networks outside of the vendors control on his/her own servers/devices, applications software and databases/storage.

Referring once again to FIG. 1, in another novel embodiment of an embodiment of the Brand and Social Media Platform, the customers such as customer A, Customer B and customer C may have associated with them various alternate mechanisms that enable the vendor to recognize the customer as a member of a particular vendor's brand network and for other utility. The customers may enabled with a smart card/gift card/credit card, 103, that contains various levels of customer specific, vendor specific or a combination of customer and vendor specific information. The smart card/gift card/credit card may also be called a loyalty card, with said cards being enabled for communication with other devices such as cellular telephones, mobile devices, stationary devices, intelligent point of sale terminals, servers and other information, computation and communication devices by wired or wireless means in a standalone manner and or in conjunction with other devices such as a mobile device and a intelligent point of sale terminal of a vendor. Similarly, the RFID, radio frequency identification card/tag, 104, containing various customer specific information/profiles, vendor specific profiles or a combination of both may be used in conjunction with a brand network to recognize a customer and a vendor and to provide differentiated services to the customer. Thus the smart card 103 and the RFID card 104 enable auto recognition of the individual and augment the utility and use of a cellular telephone, mobile device and a stationary device and may be used for payments and other utility in a brand network.

The wired or wireless communication path 110, enables communication between the smart card 103, the RFID card/Tag 104 and other devices and systems locally such as with an intelligent point of sale terminal, a CT/MD, a SD and one or more servers or across the Internet. Payments may be made via the smart card 103, the RFID card/Tag 104, the CTMD, 100 or the SD 101. Additionally incentives and points may be stored within the smart card 103, the RFID card/Tag 104 or the CT/MD 100. Further coupons and other types of promotions may be stored, downloaded, redeemed, traded, shared and used by other means via the CT/MD 100, the SD 101, the servers 102, smart card 103, and the RFID card/Tag 104 by the individual him/her self or by other users/customers selected by the individual/customer. The smart card and the RFID card/Tag is intended to be carried or worn as the user sees fit.

The intelligent point of sale terminal is enabled for reading and recognizing said cards/tags and devices and enabled for tracking transactions by itself or in conjunction with the databases resident within the intelligent point of sale terminal or in conjunction with databases resident on an external local, central, and Internet servers; and a GPS server that has location determining capability to determine the specific location of various members by themselves and the location of various members of a brand network; including the location of one or more vendors. This novel embodiment of an embodiment of the Brand and Social Media Platform thus enables dynamic utility of a brand network and a personal referral network to one or more customers/members and vendors for provision of products and services to various brand and personal referral network members.

An embodiment of the Brand and Social Media Platform also provides for a hosted model, represented by 150, wherein the servers, devices, storage, databases and applications software are made available by a remote third party. Said hosted services are accessible by wired or wireless communication by one or more vendors V-1, 120; V-2, 130 and V-3 140 and customer A, 160, customer B, 170 and customer C, 180 and so on to customer N. Said hosted services are available exclusively to members of a specific vendors brand network or in the case of shared brand networks (social networks) 153 to the vendors V-1, V-2, V-3 and V-N in conjunction with specific rules governing such shared brand networks (social networks). The customers A, B and C have their own hosted databases accessible by the customer and or his/her designees with permission and privacy levels set for different members of his/her personal referral network. Additionally the customer may enable one or more permissions for vendors to communicate with him/her. An embodiment of the Brand and Social Media Platform enables the hosted services for use by one or more customers related to a specific brand network of a vendor; for use by one or more vendors; and one or more individuals/customers on a dedicated basis or a shared basis with preset rules for security and privacy of the information contained in said personal referral/collaboration networks and vendor's brand networks (social networks).

The utility and novel features of an embodiment of the Brand and Social Media Platform are further explained in conjunction with the following illustrative examples:

### Example 1, Brand Marketing for Sit-Down Restaurants

Referring to FIG. 1, a sit down restaurant represented for illustration purposes as vendor-1, 120, enables a brand network for its current and future customers, with the intent to know its specific customers in detail, better cater to their requirements, offer promotions and further leverage their ability and willingness to refer others to the vendor-1 brand network. The brand network of vendor-1 is represented for illustration as brand network BN1, 186 comprising of existing customers and providing the capabilities for these customers to network with others who may be referred into BN1, 186.

The referring customer and the prospective customer may be offered different levels of incentives and promotions as the vendor sees fit. The vendor-1 provides the customer capabilities to establish a personal profile including a culinary/culinary preference profile, take out profile and other profiles for various utilities. Customer A may refer various customers 1-N to join the brand network of vendor-1 and customer A may also network with selected members of the set 1-N to form his/her personal referral network for a desired utility. Similarly, the referred customers may in turn refer other customers to join the brand network of vendor-1 and or vendor-2. By extension the utility is apparent for one or more vendors who are enabled via such brand networks (social networks) to increase their customer base and increase their sales by referral brand marketing. Customers are enabled to review various menu items and share their reviews with the general public or limited to sharing information within their own personal referral network. The communication between the vendor and various members of a brand network is enabled by audio, video, e-mail, voice mail, video mail and other means so that collaboration with one or more parties is enabled. Similarly collaboration between a first customer and one or more others within the first customer's personal referral network is also enabled. An embodiment of the Brand and Social Media Platform enables the vendor to track various metrics related to a customer such as the favorite menu items, frequency of visits, demographic information and other specific and broad trends for personalized and or targeted interaction with a customer in such a brand network.

Additionally, customer 1 may collaborate with customer 2 to pick up a take out order for customer 2 if customer 1 is in the specific restaurant by appropriate collaboration settings and alerts set by customer-1 and customer-2 independently [including in conjunction with a personal referral network wherein customer-1 and customer-2 are members of said referral network]; or in conjunction with the brand networking platform of vendor-1

Further, the restaurant vendor-1, 120 may wish to create/enable a shared network with another vendor such as a vendor-2 who may sell pasta or pasta sauce, such as ingredients used by vendor-1, to enable co-operative brand marketing of vendor-2's products using vendor-1's brand network platform to drive complementary sales of vendor-2 and enable vendor-2 to build out his non competing brand network for mutual synergy; wherein the benefits for such cooperation to vendor-1 may be better raw material/ingredient costs, such as lower prices for pasta/pasta sauce supplied by vendor-2 to vendor-1. Potentially such synergy between two brand networks (social networks) may benefit customers with net lower prices or access to promotions/coupons and so on. In the event the sit down restaurant is a chain with multiple branches, then brand network that are targeted for a specific location or across the entire chain may be deployed by the vendor.

The individual customer via the vendor-1 brand network platform is enabled to track his/her promotions, points, incentives and provided tools for various types of culinary, consumption and other patterns including expenses thereof. Such information may be tracked securely via a website, on a cellular telephone, a mobile device, a smart card, a RFID card, a stationary device, a server or a combination thereof for selected utility at a selected time and in a selected location leveraging the processing power and databases of the respective devices or a combination thereof. Thus an embodiment of the Brand and Social Media Platform provides a system and tools for brand networking, brand management and customer relations management to for the sit down restaurant vendors for various types of real time communication or for communication at selected times for selected purposes; and further enables collaboration between one or more customers through personal referral networks of the customer.

### Example 2, Brand Marketing for Fast Food Restaurants

In the prior art the fast food restaurant or the chain of fast food restaurants do not have any knowledge of specific individual customers and generally has broad demographic information related to the specific location of a specific fast food restaurant/branch location. However, with the population being highly mobile, the customers of a fast food chain generally may eat in more than one location and this is especially true when they are near their home, office or while they are traveling. Significant benefits are likely to accrue to the fast food restaurants, sit down restaurants, grocery stores and other establishments if they subscribe to the adage, “Know your customer”. Detailed knowledge of the individual customer is enabled in an embodiment of the Brand and Social Media Platform through the brand networks (social networks) and the associated member customer profiles including a photo optionally provided by the customer.

Referring now to FIG. 1 in detail, Vendor-1, 120 is a fast food restaurant chain having one or more fast food restaurants/outlets located across a city, country, or the world. Vendor-1 in an embodiment of the Brand and Social Media Platform is enabled to deploy a brand network to connect and stay connected with individual customers by various types of communication/computation devices belonging to the customer, CT/MD 100, SD 101, Servers 102, smart cards/gift cards 103 and RFID cards/tags 104 and wired or wireless communication paths 110; in conjunction with various devices belonging to the vendor 120 such as various intelligent point of sale terminals, servers and other equipment located at a store or across the vendor-1's network. The Vendor enables a brand network BN1, 186 to enable the customer to maintain a customer profile which includes various information relevant to the vendor and the customer, optionally customers photo, smart card, RFID card, credit card and other information to the extent desired by the customer only and the vendor only or a set of information that is mutually acceptable. Customer is enabled to select various levels of privacy for one or more pieces of information and its accessibility across the brand network.

The customer/vendor is enabled to track various types of information such as the types of items purchased, the frequency of purchases, the location of purchases, the prices and total amounts expended, the caloric and nutritional information, points earned, promotions received, promotions redeemed and various other information as may be pertinent to the customer/vendor.

The purchases may be made by the CT/MD 100, the SD 101, the smart card/gift card/credit card 103 and the RFID card/tag 104 in conjunction with the vendor-1's intelligent point of sale terminal, local and network servers by wired or wireless communication path 110 and manual sales clerk intervention or automatic recognition of said devices/cards by the intelligent point of sale terminal; including the ability for the transaction information to be archived for contemporaneous utility or for utility at a selected time on the vendor-1's devices/servers/databases and or a selected set of user specific information being archived on the customers devices/cards/servers for customer utility and automatic tracking.

In another novel embodiment of an embodiment of the Brand and Social Media Platform, the customer profile optionally including a photo may be displayed on the display screen of the intelligent point of sale terminal or other display devices for personalized services by the fast food restaurant. The customer may pay via the CT/MD 100, the SD 101, the smart card/credit card/gift card 103 and the RFID card 104 for various services/purchases; wherein the customer has the ability to replenish the funds available in said devices and cards in conjunction with his/her personal servers, banks and other institutions. The customer has the ability to track various relevant information related to all transactions with vendor-1 whether the transaction happened in Hong Kong branch location of vendor-1 or the Honolulu branch location of vendor-1 seamlessly including tracking the currency and the time of transactions.

In another novel embodiment of an embodiment of the Brand and Social Media Platform, various restaurants, especially fast food restaurants in recent times have been subject to extortion by spurious claims of foreign objects in their food/parts of human anatomy/poisonous substances/stale foods and or excessive temperatures. The fast restaurants need brand networks (social networks) of an embodiment of the Brand and Social Media Platform for knowing their customers and the frequency of their visits and types of purchases to better serve their customers with palatable food items and changing demographic tastes, fads and requirements. However, the fast food restaurants also need the brand networking of an embodiment of the Brand and Social Media Platform as a tool for tracking their customer's habits to protect the fast food restaurant from legal liability and as a tool for legal defense. In addition, there have been suggestions and lawsuits that allege that a fast food chain is responsible for obesity as the customer alleges that he frequently ate there. Brand networks (social networks) of an embodiment of the Brand and Social Media Platform enable the customer and the vendor to track the specific consumption habits of a specific customer; and enable the Vendor-1 in this case to provide legal disclaimers and email and other real time alerts to the customer to avoid future potential legal liability.

The brand networking system of an embodiment of the Brand and Social Media Platform additionally enables the customer C, 180 to refer one or more other individuals to join the brand network BN1, 186 of vendor-1, 120. The referred individuals are further enabled to refer other individuals for growing the brand network of vendor-1. Likewise, Customers are enabled to grow their own personal referral networks C-RN1, 182 and so on. Brand networks (social networks) of an embodiment of the Brand and Social Media Platform are a very useful tool for efficiently communication with various members of the brand network of vendor-1 for promotions of products and services offered by Vendor-1. In recent times certain fast food restaurants have significant degradation in sales at a selected location and across the entire chain as a result of an allegation or adverse publicity whether the facts justify this negative press or not. Brand networking of an embodiment of the Brand and Social Media Platform is an efficient tool for the vendor as it provides a face and details about all customers in vendor-1's network and enables the vendor to offer balanced information to counter said negative press. Additionally coupons/promotions may be offered to the members of the brand network to maintain and or win their loyalty/patronage.

Thus an embodiment of the Brand and Social Media Platform provides a system and tools for brand networking, brand management and customer relations management to for fast food restaurant vendors for various types of real time communication or for communication at selected times for selected purposes; and further enables collaboration between one or more customers through personal referral networks of the customer.

### Example 3, Brand Marketing Networks for Grocery Stores

In another novel embodiment of an embodiment of the Brand and Social Media Platform, brand networks (social networks) may be enabled for grocery stores and grocery store chains. Grocery stores often do not know their customers down to the specific individual level. While restaurants and grocery stores may communicate in recent prior art via e-mail to their customers, they do not use brand networks (social networks) of an embodiment of the Brand and Social Media Platform with the capability of a very rich and comprehensive customer profile tailored to their specific business; nor do these offerings enable the referral of other customers to the brand network of the vendor. Consequently, the vendor at best has an email address but may not in detail even know whether the e-mail is that of a male, female, adult or a child or their product/service preferences.

Rao et al teach customer profiles [optionally including a photo] and the vendor to communicate by various means including e-mail various types of culinary, food, beverage, nutritional and caloric values, recipes, menu items, receipts. This information may be used for tracking said information using stationary or mobile devices such as CT/MD 100. An embodiment of the Brand and Social Media Platform further presents novel features that enable brand networking to be deployed for culinary and other utility for restaurants, fast food establishments and grocery store applications.

Brand networks (social networks) of an embodiment of the Brand and Social Media Platform for grocery stores enable the vendor to deploy a brand network specific to a selected single store or for that matter to a number of stores that form a grocery store chain having either physical in store purchasing capabilities or online purchasing capabilities. Customers are enabled to refer one or more other individuals to the vendors brand network and also enabled to form personal referral networks for collaboration between one or more customers.

The customer is enabled to access and use the brand marketing network of say vendor-1, 120 who maintains multiple physical store locations and also an online presence for access by the customer via the wired or wireless communication path 110 using customer devices CT/MD 100, SD 101, servers 102, smart cards/credit cards/gift cards/affinity cards/other cards 103, RFID cards/tags 104 and processing/software/databases resident therein in conjunction with various devices/servers/intelligent point of sale terminals and software/database applications of the vendor-1 120. The wireless network within a grocery store [and by analogy other stores for other applications such as fast food restaurants, retail establishments] is enabled to recognize the customers devices/tools/cards by automatic communication means and enables an environment for selected information acquirement and transactions in conjunction with the vendor-1's brand network and the vendor-1 devices/systems and software. The customer is enabled to transact and track various parameters including his/her culinary preferences and food/non food purchases.

Customer is enabled to collaborate with others who are remotely located or proximately located within the store to purchase and pickup items desired by the first customer and the second customer who is part of the referral network of the first customer. Specials and coupons/promotions and other information may be communicated by the vendor to the customer within the store or outside of the store via the brand network for access by the customer using his/her preferred devices/cards. The intelligent point of sale terminal recognizes the customer and offers differentiated services to the customer who is part of the vendor-1's brand network.

Grocery stores generally are loosing market share to other large retailers that sell certain items of food but not a complete set at prices that are significantly lower than what the grocer offers. Thus the grocer is loosing high margin business and has to contend with offering up to 30,000 items of various lower margin items. Brand networks (social networks) and personal referral networks of an embodiment of the Brand and Social Media Platform enable the grocer to offer pricing discounts to selected customers based on tracking their individual items and total purchases. Additionally, the grocer is enabled to offer larger discounts and specials to select customers that have a large personal referral network and the entire list of customers within such personal referral networks.

The above applications and uses of the brand networks (social networks)/referral networks are for illustration purposes and are not to be construed as limiting.

An embodiment of the Brand and Social Media Platform provides a system and tools for brand networking, brand management and customer relations management to for the grocery store vendors for various types of real time communication or for communication at selected times for selected purposes; and further enables collaboration between one or more customers through personal referral networks of the customer.

### Example 4, Brand Marketing and Brand Positioning of Legal Prescription Medications, Drugs, Devices and Ancillary Supplies to Consumers

Major pharmaceutical drug manufacturers generally market different brands of their drugs through medical representatives that generally call on various doctors, hospitals and pharmacies to inform and convince the doctors/hospitals/pharmacies to use their brand of a specific drug targeted for a specific ailment and specific group of patients who are afflicted with a certain health condition. In addition, significant funds are expended in advertising in the print media, on broad cast media and the Internet. However, in the prior art the drug companies do not generally have a knowledge of the specific, individuals to who a prescription has been written by a doctor and those who actually use their brand of the drug. The safe and efficacious use of prescription drugs in conjunction with other factors such as diet and physical activity is at best known only to the patient in real time and the doctor at best is aware of these patient related factors during office visits.

An embodiment of the Brand and Social Media Platform enables drug companies to launch brand networks (social networks) relating to their overall company as a brand name; and sub brand networks (social networks) related to individual branded products [products 1-N] within this overall company brand network, for targeting specific drug related information to specific individuals/customers afflicted with selected health conditions. The filling of prescriptions is of course a separate and distinct operation best performed per existing regulations through pharmacies. However, brand networks (social networks) of an embodiment of the Brand and Social Media Platform fulfill the need to augment the information provided by doctors and pharmacies to current and potential users/customers.

For example, Better Drugs Corporation, BDC [fictitious name] manufactures a series of drugs for heart disease and blood pressure management. Prescription drug named Alpha is intended for heart disease management where as prescription drug Beta is for blood pressure management. BDC normal drug delivery channel is through prescription written by doctors and made available to patients through pharmacies and hospitals/clinics. However, BDC intends to develop a strong customer loyalty program through direct communication with its branded drug users for providing information and other tools for the patients to manage various aspects of their personal health and for gaining direct knowledge about individual customers. An embodiment of the Brand and Social Media Platform via personal referral networks managed by individual customers and brand networks (social networks) managed by the vendor enables in depth connection to the individual customer where as in the prior art this ability to know the individual customer is not there and at best there is limited knowledge derived from market research/focus groups of customers in the aggregate.

As an example Vendor1, 120 in FIG. 1 could be company BDC, in an embodiment of the Brand and Social Media Platform is enabled to provide a web based solution where in customer/patient A, 160; B, 170; C 180 through N are enabled to join the overall BDC brand network or various BDC sub brand networks (social networks) for specific products such as Alpha and or Beta. The individual/customer/patient creates a profile comprising of relevant information pertinent to the specific health condition and or includes other information including a photo [optional] and is enabled to track various information regarding the drug Alpha and or Beta; various information related to his/her specific ailments, and other ancillary information such as the ingestion of different types of foods, drinks, tobacco and other products; types of physical activity, mental activity and other factors as may be pertinent to personally manage certain health factors and or to provide information that enables the BDC drug company to provide discounts, coupons and other loyalty benefits for redemption at a pharmacies and or at over the counter sales channels. BDC company is in turn enabled in an embodiment of the Brand and Social Media Platform to analyze various trends, efficacy of its drugs and even recall its drugs should adverse results be evident. The customer/patient is further enabled to securely maintain the full set or partial set of the data on the BDC server or on a separate hosted server with the ability to access the various brand networks (social networks)/software application enumerated in here using a cellular telephone, mobile device and or a stationary device; and is further enabled to collaborate with the BDC drug company, his/her health care provider/doctors and others as he/she sees fit. In addition, the Customer/patient A is enabled to refer others such as family members to join his/her personal referral network for oversight and other utility. Additionally, the customer/patient may refer other individuals afflicted with a certain health condition to join such a referral network [of course with appropriate health care provider oversight as and when needed] with the result that the brand network of the BDC Company grows and sales of the drugs Alpha or Beta grow. Customers are enabled in an embodiment of the Brand and Social Media Platform to create and manage support groups for a specific ailment or condition to share the latest information and personal experiences for managing a specific health condition and or general health conditions.

An embodiment of the Brand and Social Media Platform thus provides a customer relations management, CRM, tool for the vendor, in this case the BDC drug company with the capability to perform complex analyses of a number of factors voluntarily provided by its customers. The brand networks (social networks) and CRM tools of an embodiment of the Brand and Social Media Platform provide another channel for marketing the company's brand [BDC drug company brand], the individual drug brands [in this case drugs Alpha and Beta] and augment other information channels such as print media and expensive broadcast media advertising. The referral networks and brand networks (social networks) of an embodiment of the Brand and Social Media Platform enable secure and real time information/communication by email, text messaging, and other forms of communication including by logging into a website using communication tools such as mobile devices and stationary devices. Additionally, the drug companies may also make their information related to various research studies directly available to their customers for the customer to make an independent and informed decision related to a specific medication by him/herself or in conjunction with a doctor. Other features and applications are too numerous to describe in here and the above example is for illustration purposes only and is not to be construed as limiting.

Thus an embodiment of the Brand and Social Media Platform provides a system and tools for brand networking, brand management and customer relations management to for the drug manufacturing vendors for various types of real time communication or for communication at selected times for selected purposes; and further enables collaboration between one or more customers through personal referral networks of the customer.

### Example 5, Brand Marketing and Brand Positioning of Legal Prescription Medications, Drugs, Devices and Ancillary Supplies Through Physicians

In the prior art the drug/device manufacturers market various drugs through medical sales representatives who have to physically call on individual doctors to talk to them and leave samples for their use. Doctors do not have the time to deal with sales representatives and often the scheduled meeting does not happen or the doctors can not allocate enough time to talk with the drug company representative to learn more about the company's overall brand and its individually branded products. In a novel embodiment of an embodiment of the Brand and Social Media Platform the drug company is enabled to create a brand network for the entire company, and sub brand networks (social networks) for its various individual products. The company is thus enabled to refer doctors, 1-N to become members of its overall brand network and or alternately the selected doctors [by physician interest or by specialty] are enabled to become members of its sub brand networks (social networks) for each said branded drug. Nurses may also be referred to join said brand networks (social networks). In this scheme the dissemination of drug company information is enabled efficiently and cost effectively, enabling savings to the company, the doctor and ultimately the patient.

The doctors in turn may create their own patient doctor networks to efficiently and securely provide information to the patient in real time or at selected times; wherein said patient-doctor networks may include other patient approved individuals such as immediate members of the patients family, for efficient delivery of information and for selected level of collaboration between the doctor and the patient and or his/her designees.

Thus an embodiment of the Brand and Social Media Platform provides a system and tools for brand networking, brand management and customer relations management to for marketing of drugs through doctors; and for various types of real time communication or for communication at selected times for selected purposes; and further enables collaboration between one or more doctors and one or more sales representatives to provide medications appropriate for the patient.

### Example 6, Brand Marketing of Over the Counter Medications and Drugs

In the prior art the retailer and the manufacturer do not have knowledge of the individual customer and his/her consumption patterns of medications and supplies such as pain killers, analgesics, cough medications and other products. In the prior art the retailer and manufacturer do not have the tools for customer relations management or for brand management. The manufacturer and the retailer depend on print, mailers/coupons, and broadcast media for promoting the specific over the counter, OTC, medication; and do not have the means to directly communicate with the individual purchaser/consumer/customer/user. An embodiment of the Brand and Social Media Platform enables a suite of customer relations management, CRM, tools through personal referral networks of the customer and brand networks (social networks) of the vendor and or the retailer.

Referring now to FIG. 1, in detail; as an example Vendor-1, 120, referred for illustration as Easy Retail Company; is a retail chain and Vendor-2, 130 referred in here as Royal Pain Company is the manufacturer of different brands of analgesics for headache and other types of body pains positioned with each product positioned for different uses and market segments, namely product Pain Killer-1 and Cough Medicine-2. Easy Retail Company in an embodiment of the Brand and Social Media Platform maintains a website that is maintained by the company and Royal Pain Company maintains its own website, both accessible by wired or wireless means from mobile and stationary devices. In addition according to an embodiment of the Brand and Social Media Platform Easy Retail Company and Royal Pain Company each implement a brand network BN-1 and BN-2 respectively enabling individuals to join their respective brand networks (social networks) BN-1 184, and BN-2, 186; and further enabling a customer C, 180 to build referral networks such as C-RN1, 182 and C-RN2, 183.

By enabling individual customers such as customer A, 160, customer B, 170 through customer-N to join their selected brand networks (social networks) of the retailer vendor-1 and of the manufacturer vendor-2 each of them independently build out their brand network; and are enabled in an embodiment of the Brand and Social Media Platform to communicate with their respective customers via e-mail, text messaging, instant messaging, video messaging, by enabling logging onto their website and other means to enable communication between the selected vendor/manufacturer and the customers within each said brand network. The customers receive information, promotions, coupons including virtual online coupons from the vendor/manufacturer instantaneously or at selected times based on their purchasing patterns. The vendor/manufacturer is enabled through the customer profile to know the specific individual customer including his/her photo if this option is selected by the customer/vendor. If the product/service of the vendor/manufacturer is satisfactory to the customer, the customer refers one or more other individuals such as friends, family, business associates and others to his/her personal referral network thus growing his/her referral network and potentially earning loyalty points from the vendor/manufacturer. The vendor/manufacturer benefit from such in depth knowledge and direct communication with multiple individual customers in their respective brand networks (social networks).

Thus an embodiment of the Brand and Social Media Platform provides a system and tools for brand networking, brand management and customer relations management to for the over the counter medications vendor for various types of real time communication or for communication at selected times for selected purposes; and further enables collaboration between one or more customers through personal referral networks of the customer and collaboration between different vendors, collaboration between the vendor and various law enforcement agencies or the combination thereof.

### Example 7, Brand Networks (Social Networks) for Complementary Product Sales

In another novel embodiment of an embodiment of the Brand and Social Media Platform the customer such as mother who buys the product Pain Killer-1 is likely to buy the product Cough Medicine-2, thus enabling the retailer, Easy Retail Company to position their product offering on the physical shelves within a store for easy selection or to offer promotions that effect the sale of Pain Killer-1 if Cough Medicine-2 is purchased or vice versa. Alternately, the complementary product information is provided for online purchases in an embodiment of the Brand and Social Media Platform by means of appropriate suggestions, prompts, e-mail, banner, text and other advertisements; and other means.

### Example 8, Shared Brand Networks (Social Networks)

Once again referring to Example 7 and FIG. 1, another novel embodiment of an embodiment of the Brand and Social Media Platform is further illustrated. The brand network of Easy Retail Company, BN1, 186 may be selectively [full set or partial set of the respective networks] merged/combined/made available/accessible to the manufacturer Royal Pain Company and its own brand network BN2, 184 for joint marketing, promotions and other utility. This availability of the full or partial set of each others brand networks (social networks) to create a real/virtual shared brand network 151, which is a sharing of the brand network of V-1 and V-2, is enabled instantaneously or at selected times and for full or selected customers therein according to defined/preset rules determined by the owner of the first brand network BN1 and the owner of the second brand network BN2; and such shared brand networks (social networks) may be created and terminated according to preset rules by enabling the devices/software and databases of vendor-1 to communicate with devices/software and databases of vendor-2 by wired or wireless communication means. The individuals/customers are like wise enabled to communicate with various websites of one or more vendors in a local network, wide area network or over the Internet using wired or wireless communication devices such cellular telephones, mobile devices, servers and stationary devices for a selected transaction or for obtaining selected information. These novel virtual shared brand networks (social networks) of an embodiment of the Brand and Social Media Platform are of great utility to one or more vendors who wish to collaborate together, to one or more vendors and manufacturers who wish to collaborate together and also to one or more customers within such respective brand networks (social networks) who wish to leverage their individual connections and communication channels for obtaining promotions, coupons and other benefits from one or more vendors, from one or more manufacturers, the selected combination of vendors and manufacturers, the selected combination of individuals/customers/potential customers utilizing their personal referral networks and range of mobile/stationary/server communication devices, software applications/databases resident within such devices and intelligent appliances.

### Example 9, Intelligent Point of Sale Appliances/Terminals

In another embodiment of an embodiment of the Brand and Social Media Platform an intelligent point of sale terminal of a vendor, is enabled for recognition of a customer/potential customer as a current member/potential member of a brand network and a referral network; such that the customer is offered in real time, selected times and or at selected events various incentives, coupons/promotions/discounts/frequent buyer points and other information/inducements for being a loyal member, for being a prolific customer who has referred other individuals to the brand network and for achieving various levels of usage/purchases.

### Example 10, Brand Networks (Social Networks) as a Tool for Tracking Purchases of Products with Alternate Uses

Various products such as chemicals, namely fertilizers have in recent times been known to be used in creating dangerous bombs and other anti-social activities. In an embodiment of the Brand and Social Media Platform, the retailer is enabled to deploy a brand network for the entire range of products sold by the retailer or for certain selected products/services sold by the retailer such as chemicals, poisons, fertilizers and other products that may have alternate and dangerous/unlawful uses. By enabling a brand network that requires a photo and other authentication information about the customer, the vendor is able to securely track various purchasing transactions including frequent and excessive purchases and report these to the law enforcement agencies for tracking and appropriate action. By having the information enabled in a shared brand network, all vendors across the country are able to track the customer's purchases instantaneously to determine that the customer is potentially engaging in potential unlawful activity that merits notification to law enforcement databases/agencies.

### Example 11, Brand Networks (Social Networks) as a Tool for Tracking Purchases of Over the Counter Medications that have Potential Prohibited Alternate Uses

Various over the counter medications such as cough syrups are reported to having alternate capability for being used as raw materials in the manufacture of illegal drugs. In an embodiment of the Brand and Social Media Platform, the retailer is enabled to deploy a brand network for the entire range of products sold by the retailer or for certain selected products/services sold by the retailer such as cough medications and other products that may have alternate uses in the manufacture of illicit drugs. By enabling a brand network that requires a photo and other authentication information about the customer, the vendor is able to securely track various purchasing transactions including frequent and excessive purchases and report these to the law enforcement agencies for tracking and appropriate action. Individuals are known to make multiple purchases of these medications to the number allowed at multiple store locations thus circumventing the limits placed on certain drug purchases. By having the information enabled in a shared brand network, all the branch stores/other vendors across the country are able to track the customer's purchases instantaneously to determine that the customer is likely engaging in potential unlawful activity that merits notification of law enforcement databases/agencies.

### Example 12, Brand Networks (Social Networks) for Individual Retail Stores and or a Collection of Retail Stores in a Physical Neighborhood or Online

An embodiment of the Brand and Social Media Platform enables brand networks (social networks) for smaller retail stores, such as shoe stores, jewelry stores, ice cream shops, hair salons and other retail establishments individually or jointly. A retail store is enabled to establish its brand network to connect with customers and communicate with them for positioning its products and services. Small stores need the volume of sales to stay profitable and do not have the resources for print, TV and other media advertising. An embodiment of the Brand and Social Media Platform enables the small store such as vendor-1, 120 to establish a brand network for existing customers/members and other potential customers who are referred by existing customers/members and who elect to be part of vendor-1's brand network. Vendor-1 may deploy a brand network on their own servers or use a hosted model as in 150. Multiple retail stores may each have their own brand networks (social networks) or form a joint shared brand network such as for all the merchants in a downtown area. Alternately, the brand network may be enabled by the merchants association or the local better business bureau for some or all of the vendors.

### Example 13, Brand Networks (Social Networks) for Service Professionals

An embodiment of the Brand and Social Media Platform enables brand networks (social networks) for various professionals such as accountants, attorneys, plumbers, dentists, doctors, electricians and others who generally operate individually or in small groups to provide services to their customers. However, these professional do not have the time or the resources to do marketing for future sales. Consequently, brand networks (social networks) of an embodiment of the Brand and Social Media Platform are best suited for them since the brand network enables the current customer to refer other individuals that are known to the current customer and who may be in need of services that may be provided by the professional. Consequently the brand networks (social networks) of an embodiment of the Brand and Social Media Platform enable better information flow and create a more perfect market for the vendor and the customer in a cost efficient manner.

### Example 14, Brand Networks (Social Networks) for Retail Apparel and Other Chain Stores

An embodiment of the Brand and Social Media Platform in another embodiment enables brand networks (social networks) for trendy items such as women's apparel and other fashion products. Retail apparel sores and chain stores are often wrong in forecasting fashion trends and are saddled with excessive inventory or very little inventory. Brand networks (social networks) of an embodiment of the Brand and Social Media Platform enable detailed knowledge of the individual customer and further enable a sub network to be created, comprising of different groups of customers based on demographics such as age, income, location and other factors for studying trends in real time with better accuracy. In addition brand networks (social networks) enable differentiated products and pricing to select groups and the personal referral networks of select customers.

At times certain apparel and other retail stores operate under two or more distinct and separate brands that at times may compete with each other and cannibalize sales from a first brand of the vendor to a second brand of the same vendor. Thus the company faces a unique challenge to dynamically balance one brand against another brand of its own. The brand networks (social networks) and personal referral networks of an embodiment of the Brand and Social Media Platform enable creation of one brand network for the vendor at large or two or more distinct and separate brand networks (social networks) with none or some of the customers being common to, said first brand network and the second brand network.

An embodiment of the Brand and Social Media Platform enables dynamic brand positioning in an ever shifting market that is trendy and further enables real time brand management. A number of hierarchical brands may be created catering to different customer segments and personal customer referral networks.

The foregoing descriptions of specific embodiments of an embodiment of the Brand and Social Media Platform have been presented for purposes of illustration and description. They are not intended to be exhaustive or to limit an embodiment of the Brand and Social Media Platform to the precise forms disclosed, and it should be understood that many modifications and variations are possible in light of the above teaching. The embodiments were chosen and described in order to best explain the principles of an embodiment of the Brand and Social Media Platform and its practical application, to thereby enable others skilled in the art to best utilize an embodiment of the Brand and Social Media Platform and various embodiments with various modifications as are suited to the particular use contemplated. It is intended that the scope of an embodiment of the Brand and Social Media Platform be defined by the Claims appended hereto and their equivalents.

1. A computer implemented method executed by at least one processor of at least one server comprising:
storing a plurality of user accounts for a first user, a second user, a first vendor and a second vendor as part of a social network platform accessible on the Internet;
making accessible on the social network platform a profile of the first vendor including a picture and a text description;
enabling on the social network platform the first user to join a network of connections of the first vendor;
enabling on the social network platform the second user to join a network of connections of the second vendor;
providing on the social network platform a referral module such that the first user is enabled invite the second user to join the network of connections of the first vendor; and
upon the second user joining the network of connections of the first vendor, enabling the first user to a receive an offer from the first vendor and enabling the second user to receive a separate offer from the first vendor, and
making the offer and the separate offer each accessible by different links to a website hosted by the first vendor.

2. The computer implemented method of claim 1, wherein the server tracks the preferences of the first user and the second user and modifies the offer in response to the preferences of the first user.

3. The computer implemented method of claim 1, wherein the first vendor profile information comprises location data.

4. The computer implemented method of claim 1, wherein the offer is sent to an e-mail account.

5. The computer implemented method of claim 1, wherein the offer is sent to a mobile device.

6. The computer implemented method of claim 1, wherein the offer is sent to a mobile device and wherein the offer is customized in response to a location information from the mobile device.

7. The computer implemented method of claim 1, further comprising: a mobile device, wherein the offer is sent to a mobile device;
and a point of sale terminal, wherein the consumption of a good, a service, or the offer is tracked by the point of sale terminal, and wherein the point of sale terminal sends the transaction data to one or more servers.

8. A method for utilizing an online network between brands and individuals, the method comprising:
storing a profile comprising a photo or text of a brand;
storing a profile comprising a photo or text of an individual; and
establishing in a computer system an online relationship network, wherein the online relationship network comprises storing an online connection between the individual and the brand.

9. The method of claim 8, wherein the online relationship network enables the brand to invite the individual to the network.

10. The method of claim 8, wherein the online relationship network enables a first individual to invite a second individual to the network by providing a contact detail of the second individual to the online relationship network.

11. The method of claim 10, wherein the first individual may receive an offer for a product as a reward for referring the second individual to create an online relationship with the brand.

12. The method of claim 8, wherein the online relationship network is a subnetwork of a larger online relationship network comprised of individuals and brands.

13. A system for tracking purchases and customer loyalty comprising:
a server, wherein the server maintains a profile for a user, wherein the server records data for the user and sends to the user's e-mail account or mobile device, an offer is customized from the one or more data items, and the data comprises one or more of purchases, locations, referrals, and online relationships.

14. The system of claim 13, further comprising a mobile device, wherein the server receives location data from the mobile device.

15. The system of claim 13, wherein the server acts as a hosted referral network for a brand, and wherein the server sends a link to the user's e-mail address or mobile device for a customized offer for a brand.

16. The computer implemented method of claim 1, wherein one or more vendors are enabled to host and maintain a shared vendor network configured to electronically and securely share between one or more participating vendors a listing of complementary products and services to one or more of their customers in the shared vendor network.

17. The computer implemented method of claim 16, wherein the shared vendor network enables the first user to accrue benefits from belonging to a first vendor's network but not explicitly belonging to a second vendor's brand network and wherein a plurality of vendors share information.

18. The computer implemented method of claim 1, wherein the first user is enabled to join a collaborative purchasing and information network.

19. The computer implemented method of claim 1, wherein the first user is enabled to pickup a take out order for a second user when the first user is in a specified restaurant by a collaboration setting and wherein a alert is enabled to be set by the server.

20. The computer implemented method of claim 1, wherein a vendor is enabled to offer a larger discounts and specials to select customers based on the size of the personal referral network of the number of contacts on the social network.

21. The computer implemented method of claim 1, wherein the first user is enabled to join a network to a certain health condition social network configured to allow a plurality of support groups for a specific ailment or condition to share the latest information and personal experiences.
